(19) United States
(12) Patent Application Publication
(10) Pub. No.: US 2007/0058612 A1
(43) Pub. Date: Mar. 15, 2007

(54) Quality of service enabled device and method of operation therefore for use with universal plug and play

(75) Inventor: Dennis Bushmitch, Somerset, NJ (US)

Correspondence Address: GREGORY A. STOBBS, 5445 CORPORATE DRIVE, SUITE 400, TROY, MI, 48098, US

(73) Assignee: Matsushita Electric Industrial Co., Ltd., Osaka (JP)

(21) Appl. No.: 11/226,736

(22) Filed: Sep. 14, 2005

(51) Int. Cl. H04L 12/66

(52) U.S. Cl. 370/352

(57) ABSTRACT

A method of operation for use with a QoS enabled device includes maintaining a record of a configuration of QoS objects present at a QoS enabled device and available for configuration. Further operation includes communicating the record to a user of the device, receiving a request from the user specifying one or more alterations to the configuration, and performing the alterations to the configuration as specified. In the case where information about the configuration is recorded in accordance with a publicly available catalog of standardized terminology developed to describe configuration elements, UPnP technology is supported. Accordingly, a UPnP enabled control point on a user device can automatically configure the QoS enabled device, greatly facilitating combination of QoS enabled and UPnP enabled user devices in a home network.

### FIELD OF THE INVENTION

The present invention generally relates to Quality of Service enabled devices and Universal Plug and Play, and relates in particular to a method of operation for a Quality of Service enabled device that facilitates Universal Plug and Play by providing a device configurator service.

### BACKGROUND OF THE INVENTION

Today's Quality of Service (QoS) enabled devices, such as edge routers, provide packet forwarding services for user devices that are commonly termed Control Points. The QoS enabled devices can have a variety of internal configurations, and the potential internal configurations for particular QoS enabled devices can vary widely depending on internal structures of the devices. For example, the QoS enabled devices can have a number of mandatory and optional internal technologies, including schedulers, shapers, markers, classifiers, admission controllers, port state supervisors reporting port link failures and making port interface control available to other devices, and others. Also, the potential properties and object state variables of individual classes of technologies can vary widely. Schedulers, for example, can be Weighted Round Robin (WRR) schedulers, Self Clocked Fair Queuing (SCFQ) schedulers, Weighted Fair Queuing (WFQ) schedulers, and others. Also, shapers may or may not use a Leaky Bucket (LB) algorithm, and markers may or may not use Random Early Detection (RED). Moreover, some QoS technologies can have multiple instances within a QoS enabled device, with several shapers deployed in front of a single scheduler, and the potential for multiple schedulers. Yet, these technologies can be configured differently, with different sets of properties and/or state variables available per a present technology deployment, and different ranges allowed by different device manufacturers for different properties. These multiple possible configurations compound the problem of configuring technology interconnection at runtime by user devices.

The aforementioned capabilities remain problematic. For example, while the configurability of QoS enabled devices is convenient to experts having apriori knowledge of the QoS enabled device at the time of configuration, user devices are not able to adapt to changes in conditions without a way a monitoring the internal technologies in detail. In other words, user devices lack the ability to perceive and modify arrangement and states of QoS technologies present on a QoS enabled device. Examples of abilities lacked by today's user devices include the ability to monitor changes in topology states and change topology of QoS objects. These shortcomings have various affects, at least some of which can be demonstrated with reference to home networks.

Home networks over Internet Protocol (IP) are likely to rely on a QoS enabled device, such as a home gateway router, to manage the home's collective bandwidth. For example, a user streaming on demand media via the home gateway router may be assured of a certain quality of service compared to another user playing an online video game and accessing the Internet via the set top box. At the same time, both users may rest assured that the home gateway router will not fail to transmit a message sent by a further user, a home security system. In some cases, the guarantee of QoS, especially for the home security system, can be obtained by the home gateway router granting the home security system priority over other users. In other cases, minimum transmission rates are guaranteed for certain classes of users, while others receive a mere best effort attempt to provide them adequate transmission rates based on available bandwidth. However, the average consumer setting up a home network is likely to encounter difficulty in properly configuring the QoS service to provide proper service levels for various users in the home.

In part, the difficulty that users face in configuring the QoS service lies in the fact that existing Universal Plug and Play (UPnP) QoS architecture has no functionality to describe in depth the availability of various QoS technologies inside the QoS enabled device. Nor do the current architectures expose the appropriate interfaces to configure interconnections and monitor performance of those technologies and their combinations. As a result, programmers attempting to render a user device capable of connecting to the QoS enabled device and automatically configuring the QoS enabled device based on its internal technologies and their performances are thwarted. Accordingly, there is a need for a QoS enabled device that is able to describe its technologies and their performances to user devices and appropriate interfaces. The present invention fulfills this need.

### SUMMARY OF THE INVENTION

In accordance with the present invention, a method of operation for use with a QoS enabled device includes maintaining a record of a configuration of QoS objects present at a QoS enabled device and available for configuration. Further operation includes communicating the record to a user of the device, receiving a request from the user specifying one or more alterations to the configuration, and performing the alterations to the configuration as specified.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is block diagram illustrating a service according to the present invention; and

FIG. 2 is a method according to the present invention.

### DETAILED DESCRIPTION OF THE PREFERRED EMBODIMENTS

The following description of the preferred embodiments is merely exemplary in nature and is in no way intended to limit the invention, its application, or uses.

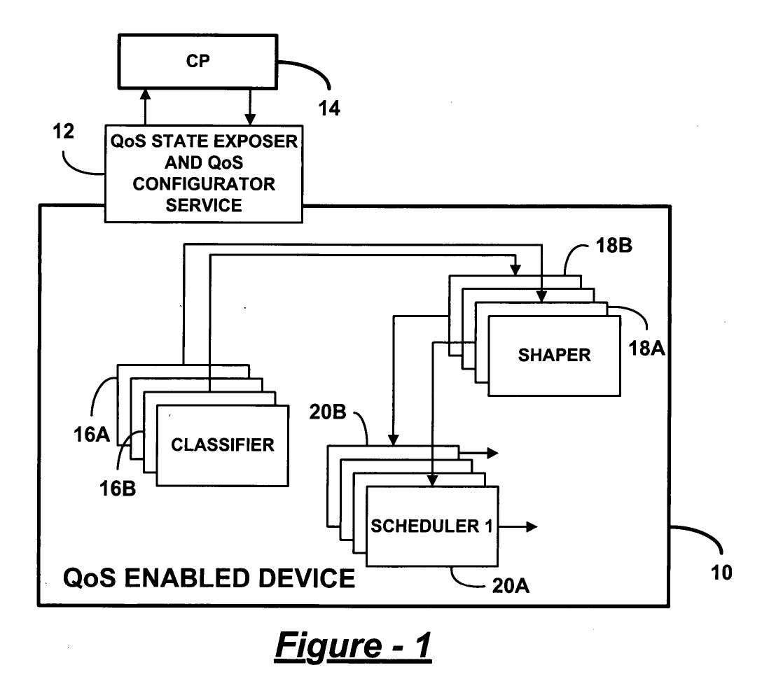

Referring to FIG. 1, a service according to the present invention can be deployed on a QoS enabled device, such as a home gateway router. In this case, QoS enabled device 10 has a QoS state exposer and QoS configurator service module 12 following a published, universal service description paradigm to allow seamless interoperability between devices. For example, the QoS state exposer and QoS configurator service module 12 provides to a user device 14 a record of QoS objects 16A-20A and 16B-20B present at the device 10 and available for configuration. These objects 16A-20A and 16B-20B represent different technologies internal to the device 10. In some embodiments, the user device 14 is able to obtain the record in the form of a browsable list of objects, with a supported properties list per object class, and allowed ranges of values for these properties. In some embodiments, the user device 14 requesting the record can provide search criteria by which the QoS state exposer and QoS configurator service module 12 can filter the record.

In addition to reporting the internal technology topology, properties, and state variables, the QoS state exposer and QoS configurator service module 12 can also accept predefined commands/actions from the user device 14 and set new values for specified QoS elements accordingly, including token rates, classifier threshold levels, interconnectivity topology between internal devices, and others. The QoS state exposer and QoS configurator service module 12 can also report on and alter state variables according to user device 14 commands, such as a current buffer occupancy for a given class. Yet further, the QoS state exposer and QoS configurator service module 12 can generate events when various QoS parameters change, such as buffer overflow (EventID#) for objectID#. Similarly, the QoS state exposer and QoS configurator service module 12 can generate an event if server utilization falls below a threshold previously set by the user device 14, allowing events to be properly moderated in frequency and/or threshold, and/or upon reaching a predefined value or value range.

In a presently preferred embodiment, the QoS state exposer and QoS configurator service module 12 effectively provides a novel middleware service architecture that allows complete control over the QoS enabled device 10 by the user device 14 or control point (CP) (e.g., UPnP). The presence of various QoS technologies in the device 10 can be interrogated by the user device 14, and the user device 14 can instantiate and terminate QoS objects for classes of technologies, query the configuration parameters of the QoS objects, and set the configuration parameters according to its needs. The user device 14 can also be permitted to query, configure, and update the overall topology of the QoS technologies' interconnection. QoS state exposer and QoS configurator service module 12 can also implement a timing service to change the topology according to traffic descriptor and QoS Requirements descriptor objects' states and/or a predefined configuration schedule and heuristics. The user device 14 can similarly be permitted to query, configure, and update the timing service, schedule, and heuristics according to its needs.

Some example definitions in the published, universal service description paradigm can include predefined methods/actions. For example, a predefined method can permit creation of a QoS object of a particular type and having particular internal functions according to the technology that it implements in the following form: CreateQoSObject(ARG_ObjectType, <Args>). This action would be published in a service description document of the service in question. Example arguments can include 3 color marker, RR scheduler, WFQ scheduler, and others. This class creator can return an ObjectID identifying the successfully created object or an error code. Also, a predefined method can permit setting of a classification rule in the following form: SetClassificationRule (ObjectID, <ArgList>). The ArgList can include timing specifications, classifier specifications, and others. Specific, standard technologies can have a list of properties governing and representing this standard, adopted, widespread technology. Example properties include Random Early Demotion and Promotion (REDP), WRR, marker, and other QoS technologies. Further the predefined methods can include a method for setting up a graph or topology of QoS modules and connecting QoS objects, such as schedulers to classifiers, classifiers to policers, and others. This method, which can return an ID of the successfully created topology object, can take the form: SetDevicelnternalQoSConfigurationTopology (QoS_ModuleStructure, Module_Topology_Structure). Yet further, the predefined methods can include a method for reconfiguring the topology, thereby changing the interconnection and corresponding arrangement of the implemented technologies. For example, a scheduler can be disconnected from buffers one and three and reconnected to buffers two, four, and five instead. This method can take the form: UpdateDeviceQoSTopology( ). Finally, an explicit topology object deconstructor can be provided to delete a topology in the form: DeleteDeviceQoSTopology(TopologyID).

In addition to allowing the user device 14 to instantiate, query, and adjust the QoS configuration, the QoS state exposer and QoS configurator service module 12 can automatically adjust the topology and configuration parameters of the QoS configuration in accordance with preset conditions specified by the user device 14. For example, the QoS state exposer and QoS configurator service module 12 can automatically adjust the topology and configuration parameters of the QoS objects within the device 10 according to a preset schedule/heuristics/conditions. For example, when a buffers threshold is exceeded, a special traffic conditioning module can be instantiated by the service in an automatic manner, with notification to a CP/user. The user device 14 can instantiate, query, and adjust this schedule according to definitions in the published, universal service description paradigm. Also, the QoS state exposer and QoS configurator service module 12 can interrogate and adjust the states of QoS objects according to predefined heuristics. For example, the QoS state exposer and QoS configurator service module 12 can interrogate the states of the traffic classifier objects 16 and buffering and scheduling objects 20, and change the states of the traffic shaping objects 18 accordingly. QoS state exposer and QoS configurator service module 12 can perform the interrogations and change states according to predefined heuristics while utilizing the same technology interfaces. These heuristics can also be instantiated, queried, and adjusted by the user device 14 in accordance with definitions in the published, universal service description paradigm.

There are a variety of ways in which the service according to the presenty invention can be deployed. For example, it should be readily understood that QoS state exposer and QoS configurator service module 12 can reside on QoS enabled device 10 coincident with QoS objects 16A-20A and 16B-20B. Also, it should also be readily understood that QoS state exposer and QoS configurator service module 12 can reside elsewhere on a network, including on control point 14, or on another device connected to the same network or virtual network as QoS enabled device 10 and control point 12. By way of illustration, a legacy router can be connected by Ethernet to a server on which QoS state exposer and QoS configurator service module 12 resides, and a control point can control the router by interacting with the server.

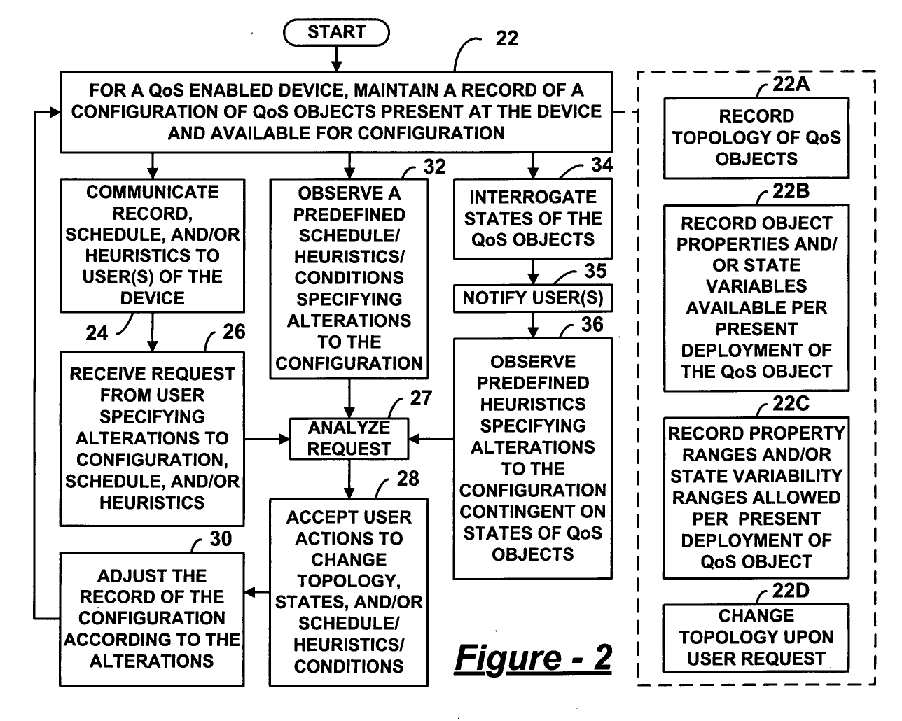

Turning now to FIG. 2, a method of operation for a service according to the present invention includes maintaining a record of a configuration of QoS objects present at a QoS enabled device and available for configuration at step 22. The record is communicated to a user of the device at step 24. A request is received from the user specifying one or more alterations to the configuration at step 26. The user request is analyzed at step 27, and the alterations are accepted at step 28. In some embodiments, the record is explicitly updated at step 30 based on the alterations as they are performed. Other embodiments allow the record to be updated through an automated interrogation procedure that occurs periodically in step 22, or explicitly accompanies step 24 as a condition precedent to communication of the record to the user.

Some embodiments allow the configuration to be altered in alternative or additional ways. For example, a predefined schedule specifying alterations to the configuration is observed at step 32. In such a case, step 24 can include communicating the schedule to the user, while step 26 can include receiving a request from the user specifying alterations to the schedule, which are performed as specified at step 28. Also, states of QoS objects can be automatically interrogated at step 34 and users notified at step 35. Predefined heuristics/conditions specifying alterations to the configuration contingent on states of the QoS objects can also be observed at step 36. In such a case, step 24 can include communicating the heuristics/conditions to the user, while step 26 can include receiving a request from the user specifying alterations to the heuristics at step 26, which are accepted at step 28.

Various embodiments can maintain the record in step 22 in various ways. For example, a topology of the QoS objects reflecting a sequential arrangement according to which packets are forwarded from one QoS object to another can be recorded in step 22A. Also, one or more of QoS object properties and QoS object state variables available per a present deployment of a QoS object can be recorded in step 22B. Further, one or more of QoS object property ranges and QoS object state variability ranges available per a present deployment of a QoS object can be recorded in step 22C. Preferably, maintaining the record in step 22 includes recording information about the configuration in accordance with a publicly available catalog of standardized terminology developed to describe configuration elements. Similarly, requests are received in step 26 and adjustments made in step 30 in accordance with a publicly available catalog of standardized terminology developed to describe functions for adjusting values of QoS objects, schedules, and/or heuristics. Changes to the topology accepted at step 28 are performed at step 22D upon return to step 22.

The method of operation for the service according to the present invention can be viewed as a method of operation for a variety of devices, depending on how the service is deployed. For example, in the case where the service is deployed on a QoS enabled device, the method of operation for the service can be a method of operation for a QoS enabled device. Also, in the case where the service is deployed on a control point, the method of operation can be a method of operation for a control. Further, in the case where the service is deployed on a server connected by Ethernet to a legacy router, the method of operation can be a method of operation for a server. Further still, in the case where the service is deployed arbitrarily on a network connected to a control point and a QoS enabled device, the method of operation can be a method of operation for a network. Other types of deployment of the service will readily apparent to those skilled in the art.

The description of the invention is merely exemplary in nature and, thus, variations that do not depart from the gist of the invention are intended to be within the scope of the invention. For example, the service architecture thus provided can target UPnP device service architecture. However, it is also applicable to any registration/action/event-based networking framework. Also, structured documents, searches, and complex document types can be supported using metadata tags, such as XML-based tags. More specifically, some embodiments can employ an XML based service description according to the following format:

<QoS Service Description>
<Action List> ...
</Action List>
<QoS object list> ...
</QoS object list>
</QoS Service Description>

Further, the service can apply to QoS enabled peer-to-peer device frameworks.
Moreover, it should be readily appreciated that some embodiments may communicate one or more of records, schedules, and heuristics, while permitting adjustment to all or a subset of that which is communicated. It should also be readily appreciated that some embodiments can permit adjustment of topologies, and state variables, while others can permit adjustment of a subset of these aforementioned configuration elements. For example, some embodiments may permit that states of classifiers and schedulers can be queried, but not adjusted, while states of shapers can be adjusted, but not queried. In such embodiments, even though the specific state of the shaper can not be queried, it may be that the state variability range of a shaper can be queried. Finally, the user may not be permitted to directly adjust configuration topology and/or states of QoS objects, but may be required to adjust a schedule and/or heuristics implemented by the QoS state exposer and QoS configurator service module. Such variations are not to be regarded as a departure from the spirit and scope of the invention.

What is claimed is:

1. A service, comprising:
a QoS state exposer and QoS configurator service module maintaining a record of a configuration of QoS objects present at a device and available for configuration, communicating at least part of the record to a user of the device, receiving a request from the user specifying one or more alterations to the configuration, and performing the alterations to the configuration as specified.

2. The service of claim 1, wherein said QoS state exposer and QoS configurator service module observes a predefined schedule specifying alterations to the configuration.

3. The service of claim 2, wherein said QoS state exposer and QoS configurator service module communicates the schedule to the user, receives a request from the user specifying alterations to the schedule, and performs the alterations to the schedule as specified.

4. The service of claim 1, wherein said QoS state exposer and QoS configurator service module interrogates states of QoS object technologies within the device.

5. The service of claim 4, wherein said QoS state exposer and QoS configurator service module observes predefined heuristics specifying alterations to the configuration contingent on interrogated states of QoS objects.

6. The service of claim 5, wherein said QoS state exposer and QoS configurator service module communicates the heuristics to the user, receives a request from the user specifying alterations to the heuristics, and performs the alterations to the heuristics as specified.

7. The service of claim 1, wherein said QoS state exposer and QoS configurator service module records a topology of the QoS objects reflecting a sequential arrangement according to which packets are forwarded from one QoS object to another.

8. The service of claim 1, wherein said QoS state exposer and QoS configurator service module records one or more of QoS object properties and QoS object state variables available per a present deployment a QoS object.

9. The service of claim 1, wherein said QoS state exposer and QoS configurator service module records one or more of QoS object property ranges and QoS object state variability ranges available per a present deployment of a QoS object.

10. The service of claim 1, wherein said QoS state exposer and QoS configurator service module records information about the configuration in accordance with a publicly available catalog of standardized terminology developed to describe configuration elements.

11. The service of claim 1, wherein said QoS state exposer and QoS configurator service module observes one or more predefined conditions for making alterations to the configuration.

12. The service of claim 1, wherein said service has a service interface adapted to connect to a control point and provide two-way communication with a user.

13. The service of claim 1, wherein said service has a plurality of QoS objects configured to forward multiple classes of traffic and perform QoS actions on the traffic.

14. The service of claim 1, wherein said service has an ability to provide a service description document specifying actions for configuring QoS objects and actions for perceiving states of QoS objects.

15. The service of claim 1, wherein said service is able to participate in a UPnP service discovery protocol.

16. A method, comprising:
maintaining a record of a configuration of QoS objects present at a QoS enabled device and available for configuration;
communicating at least part of the record to a user of the device;
receiving a request from the user specifying one or more alterations to the configuration; and
performing the alterations to the configuration as specified.

17. The method of claim 16, further comprising observing a predefined schedule specifying alterations to the configuration.

18. The method of claim 17, further comprising:
communicating the schedule to the user;
receiving a request from the user specifying alterations to the schedule; and
performing the alterations to the schedule as specified.

19. The method of claim 16, further comprising interrogating states of QoS object technologies within the device.

20. The method of claim 19, further comprising observing predefined heuristics specifying alterations to the configuration contingent on interrogated states of QoS objects.

21. The method of claim 20, further comprising:
communicating the heuristics to the user;
receiving a request from the user specifying alterations to the heuristics; and
performing the alterations to the heuristics as specified.

22. The method of claim 16, wherein maintaining the record includes recording a topology of the QoS objects reflecting a sequential arrangement according to which packets are forwarded from one QoS object to another.

23. The method of claim 16, wherein maintaining the record includes recording one or more of QoS object properties and QoS object state variables available per a present deployment of a QoS object.

24. The method of claim 16, wherein maintaining the record includes recording one or more of QoS object property ranges and QoS object state variability ranges available per a present deployment of a QoS object.

25. The method of claim 16, wherein maintaining the record includes recording information about the configuration in accordance with a publicly available catalog of standardized terminology developed to describe configuration elements.

26. The method of claim 16, further comprising observes one or more predefined conditions for making alterations to the configuration.

27. The method of claim 16, further comprising connecting to a control point and provide two-way communication with a user.

28. The method of claim 16, further comprising employing a plurality of QoS objects configured to forward multiple classes of traffic and perform QoS actions on the traffic.

29. The method of claim 16, further comprising providing a service description document specifying actions for configuring QoS objects and actions for perceiving states of QoS objects.

30. The method of claim 16, further comprising participating in a UPnP service discovery protocol.

31. A method, comprising:
maintaining a configuration of QoS objects present at a QoS enabled device;
observing a predefined schedule specifying alterations to the configuration;
performing the alterations to the configuration as specified by the schedule;
communicating the schedule to a user;
receiving a request from the user specifying alterations to the schedule; and
performing the alterations to the schedule as specified by the request.

32. The method of claim 31, further comprising:
maintaining a record of the configuration; and
communicating the record to the user.

33. The method of claim 31, wherein the QoS objects are at least one of buffers, schedulers, markers, traffic conditioners, combinations thereof, topologies of combinations thereof, or connections of combinations thereof.

34. A method, comprising:
maintaining a configuration of QoS objects present at a QoS enabled device;
interrogating states of the QoS objects, thereby producing currently interrogated states;
observing predefined heuristics specifying alterations to the configuration contingent on interrogated states of QoS objects;
performing the alterations to the configuration as specified by the heuristics and based on the states;
communicating the heuristics to a user;
receiving a request from the user specifying alterations to the heuristics; and
performing the alterations to the heuristics as specified by the request.

35. The method of claim 33, further comprising:
maintaining a record of the configuration; and
communicating the record to the user.

36. The method of claim 34, wherein the QoS objects are at least one of buffers, schedulers, markers, traffic conditioners, combinations thereof, topologies of combinations thereof, or connections of combinations thereof.
